(19) United States
(12) Patent Application Publication
(10) Pub. No.: US 2004/0003530 A1
(43) Pub. Date: Jan. 8, 2004

(54) Methods for deterring ruminants using low porosity ovoid reflecting repellent bodies

(76) Inventor: Catherine M. Younker, Briarcliff Manor, NY (US)

Correspondence Address: Catherine M. Younker, 391 Hardscrabble Road, Briarcliff Manor, NY, 10510, US

(21) Appl. No.: 10/190,802

(22) Filed: Jul. 8, 2002

(51) Int. Cl. A01M 1/00

(52) U.S. Cl. 43/1

(57) ABSTRACT

Deterrence of ruminants and other animals is greatly enhanced by the placement of activated sewage sludge, blood meal, or other repellent substances inside low porosity ovoid bodies having low surface to volume ratios and specularly reflecting outer surfaces. The low-porosity ovoid repellent bodies all long-time effectiveness of the repellent substance(s), and the ovoid shape can resemble a predator eye, causing discomfort and avoidance.

### BACKGROUND OF THE INVENTION

Browsing damage caused by elk, roe deer, other ruminants, fissiped game and wild animals has become a serious problem in the last three decades as human development has spread to once-rural areas and as animal populations have grown with the decrease of populations of predators such as wolves and coyotes. The population of ruminants and other animals has thus grown to such a size that browsing damage has become significant economically and socially, particularly in suburban areas that lack game hunting or predatory processes.

Many methods, including acoustic, optical and chemical methods, have been used in attempts to discourage roe deer, elk, hart, and other ruminants from inflicting browsing damage adjacent to homes, in gardens, fields, orchards, forest plantations, and on agricultural assets. Chemical methods have attracted a lot of attention over the years, primarily because deer and other ruminants have such highly developed sensory organs for molecular secretions, and have such a highly developed intelligence for what they sense.

Deer, for example, rely on their sense of smelt to warn them of the presence of predators and to assist in finding new sources of food and water. It is well known among hunters that even a slight scent of a human, despite his having taken precautions such as bathing and laundering of clothes, can figure in deer learning of their presence even large distances away, allowing their escape. Deer also use their sense of smell to communicate with other deer. By discriminating scents, deer can recognize other deer, learn about the other deer's sex, dominance status, reproductive state, etc. Using highly sophisticated analytical equipment, a number of suspected compounds have been identified, but it is only speculation as to what these compounds signify to the deer. Some of these compounds have been tested to see how deer react to them; however, in many cases deer do not react to them at all. Deer often detect substances without eliciting a behavioral response. Certainly, the context in which the scents are presented certainly influences how a deer may respond.

One avenue for discovery is examining different glandular areas on the deer. Studies have been done to watch behavior of the animals to divine when and how these glands are used. The structure of these glands has also been examined microscopically to determine how they differ between sexes, age classes, and times of the year. Electronic monitoring equipment can determine when these gland are active. Many glands have been identified, and more are likely to be discovered.

At present 7 different glandular areas have been discovered, among them is the interdigital gland, located on all four feet in a small sparsely-haired sac that opens between the toes. In this sac is found a yellowish, cheesy material. This accumulation is the result of sloughed cells and glandular secretions, and has a foul, rancid odor. Some of this scent is left in a deer's track every time it takes a step. Several years ago at the University of Georgia several compounds associated with this gland were found to be sets of volatile fatty acids. These molecules have different vapor pressures, and would evaporate or dissipate at different rates, allowing the overall odor of the track to change over time which may be how it is that a deer (or a predator) can tell how old the track is and which way the track is headed. Recently, 46 volatile compounds from this interdigital scent were identified; 5 of these compounds occurred in much greater concentrations in dominant bucks than in subordinate bucks. Another glandular area is the metatarsal gland, located on the outside of the deer's hind legs, and consisting of an oval ring with whitish hairs that surrounds a black callous area. The area under the hairs has large numbers of enlarged sebaceous glands. In mule and black-tailed deer, this gland is much larger than in whitetail deer and has been shown to be the source of an alarm pheromone (scent) that can alert other deer in the area to the presence of danger, such as due to the presence of predators. Although it is possible that this gland serves the same purpose in whitetails, it may be vestigial. Some races of whitetails such as those in South America and Central America completely lack this gland. Among the most important glands in whitetail deer is the tarsal gland, located on the inside of the deer's hind legs. These glands consist of a tuft of elongated hairs that is underlain by an area of enlarged sebaceous glands. The tarsal glands secret a lipid which adheres to the long hairs. The strong smell of this gland is well known to hunters, but the strong smell is actually due to urine deposited on the gland, in a process called rub-urination. As the urine runs over the tarsal gland, the lipids secreted from the glands onto the hairs selects out some molecules and holds them on the gland. Deer generally urinate on these glands all year, including fawns less than a month of age. Most of the time the excess urine is licked off of the gland. However, during the breeding season the males, and primarily the dominant or mature males, urinate onto the tarsal much more frequently. They also no longer lick off the excess urine from the gland. This frequent ruburination, along with chemical changes, is what stains the gland dark and gives the buck its rutting odor. A study of the secretory glands underlying the tarsal tuft revealed that the activity of these glands was constant year-long, with no difference in activity between sexes. The tarsal tuft fosters bacterial growth, and a number of species of bacteria have been identified, and a very complex interaction is occuring between between lipids secreted by the gland itself, urinary deposition of additional compounds, and bacterial alteration of these compounds. It appears likely that the tarsal gland is somewhat analogous with the human underarm where bacterial changes to bodily secretions produces individual scents. The tarsal gland is thus used by deer for deer-to-deer recognition. The preorbital gland is located in a small pocket between the deer's eyes. Usually the pocket is closed, except when it is under muscular control. It is believed that rutting bucks may open this gland when signaling their aggressive intents to other bucks or predators. Does often open this gland when they are tending their fawns. Some researchers and hunters have suggested that the preorbital gland area is used to mark the overhanging branch at a scrape site, and it is common to see a buck marking an overhanging branch using the whole head, including antlers, nose, mouth, and preorbital area. In addition, the forehead gland, located in an area between the antlers and the eyes is a very important gland in whitetail deer. Skin in this area contains large numbers of apocrine sweat glands. These glands become more active during the rutting season in all deer, but the greatest amount of activity occurs in dominant, mature bucks. Bucks often use the base of the antlers and the forehead region to make a rub on a branch, often pausing to lick or smell the rub before leaving. Does have been observed rubbing their foreheads on antler rubs made by bucks. Finally, inside the nostrils of deer are two almond shaped glands in fluid communication with the nostril. Additionally, the preputial glands on whitetail deer are located on the inside of the buck's penal sheath, comprising clusters of very enlarged sebaceous glands associated with very long hairs that extrude therefrom.

The foregoing makes it obvious that deer use glandular odors in many ways to insure their survival and the detection of smells is also of vital importance. Deer have two regions responsible for detection of these and other olfactory responsive compounds—a nose with an extremely sensitive olfactory apparatus and associated neural architecture, and a vomeronasal organ (VNO) in a diamond shaped structure on the roof of the deer's mouth, in an small passage leading into the palate. This VNO is similar to the Jacobson's organ in snakes. Deer use the VNO to analyze urine. When a buck sees a doe urinate, he will often perform a behavior called flehmen, or lip-curl taking this urine into his mouth. This introduces the urine into the VNO. Since the VNO is connected solely to the part of the brain that controls the reproductive condition, it is likely that this behavior helps bring the buck into rutting condition at the right time. [see reference: “Deer ‘Talk’ with Their Noses,” Dr. Karl V. Miller, Daniel B. Warnell School of Forest Resources, The University of Georgia, ©2002]

The prior art capitalizes on the extraordinary sensory powers and intelligence of deer and other ruminants in attempting to repel them from protected areas. However, one problem for prior art devices is that the repellent substance being used is spread for maximum diffusion or outgassing in an arbitrary way, and in a manner that leaves the repellent(s) exposed to the elements. This leads to fast depletion of deterrent effect by such processes as evaporation, and chemical and biological degradation.

Furthermore, it is important to realize that deer and other ruminants are capable of reasoning to some extent, and often will not be deterred by merely spreading a repellent throughout an area (such as spreading predator blood products on tree bark, for example) or by merely making the odor or volatile molecular fractions of the repellent substance available to ambient air. And while deer and other ruminants may be deterred for a short while by traditional repellent methods such as optical techniques like game mirrors, or by making predator biological products like urine, blood, steroids, sweat, hair, etc., available to the ambient air, they also adapt and become familiarized with the new stimulus, and can learn to disregard the sights and many smells and other signals that they later discover do not actually represent a bona fide predatory presence. This is a serious problem with prior art methods of deterrence. Acoustic methods, in particular, have proved to be almost useless, as deer and other animals familiarize themselves quickly to the new sounds. As for smells, deer in suburban locales, for example, quickly Learn the smell of Local residents and their pets such as dogs, and learn to work around their schedules and habits. Rather than evacuate an area, in this instance, they would simply disregard the smell and proceed cautiously.

However, it is well known that animals react to smells associated with predators by avoiding the area in question, or by running away. But the delivery and exposure of repellent substances associated with predators to air around the area to be protected does not guarantee effectiveness, due to familiarization and accommodation on the part of ruminants and other animals, and due the evaporation, and biological and chemical degradation cited above.

It should be noted that the problem of deer control is acute, and challenging. The emphasis in this disclosure in on the control of behavior of deer and other ruminants, but only because they represent a challenge, and merit discussion as a test of effectiveness. The entire class of arteriodactyls and other ruminants is contemplated by this teaching, as well as other animals who browse or cause plant damage.

The prior art teaches various methods for deterring browsing among ruminants. In U.S. Pat. No. 3,980,773 to Oh et al., fresh phospolipids, extracted from animal or plant lipoidal material such as eggs, are used as repellents, including components lecithin and cephalin.

U.S. Pat. No. 4,451,460 to Hansen et al. uses a method for repelling animals by placing smelling repellent substances in the area to be protected, where the repellent substances are synthetic or extracted steroids of the type found on human skin, hair, sweat, or urine, or where the repellent substances are derived by subjecting the steroids to air, moisture or micro-organisms. The base steroids for this process are selected from the group consisting of testosterone, androsterone, dehydorepiandrosterone, 11-ketoaeticholanalone, i-androstanalone, oestrone and androstenol.

U.S. Pat. No. 4,818,535 to Baines et al. teaches the use of a repellent composition for repelling deer which comprises a synthetic blend of compounds that are derived from the acid fraction of a Soxhlet reaction performed upon lion feces. The extracted material is separated into basic, neutral and acid fractions and felinine is added. The resulting composition comprises saturated alkanoic acids, saturated aliphatic alcohols, and various other amino group-containing compounds.

U.S. Pat. No. 4,965,070 to Messina discloses a deer repellent formulation comprising water, thiram, chicken eggs, liquid hot sauce, coloring dye (to mask the composition) and adhesive.

U.S. Pat. No. 6,159,474 to Davidson teaches the use of a repellent derived from essential oil of black pepper or capsicum and an oleoresin of either black pepper or capsicum, along with an antioxidant to reduce spoilage. Along with a carrier such as lard, the teaching given recommends spreading it along the ground.

U.S. Pat. No. 6,254,880 to Messina teaches the use of repellents made from water, eggs, adhesive and animal blood. The mixture may be applied to a support such as clay or rope to protect an area.

There are serious problems with these approaches as embodied in the above patents. The repellents used involve gathering or preparing proteins, steroids, lipids, or other specialized substances that have a short effective lifetime, and are often expensive. The method for delivering these repellent substances to the outside air or the area to be protected leaves the active repellent material physically exposed to the elements and outside air. This causes physical evaporation and chemical degradation to reduce quickly the vapor pressure and diffusive capacity of the repellent, leaving the intended stimulus of smelt to become state and weak. It is not uncommon for the repellent effect afforded by prior art methods to become ineffective within hours or days. Our work has revealed that there is no reward in deterrence effect by “over” outgassing or over-diffusing a repellent substance-there is only a severe drop in the deterrent action as a function of time when the concentration of active deterrent molecules falls below minimum effective Levels as a result of overexposure and attendant outgassing. It also leaves the repellents vulnerable to biological degradation, due to both the actions of micro-organisms and insects, causing rotting and spoilage and a large decrease in the deterrent effect. Deer can sense, for example, old or rotting biological tissue, and understand that it does not represent a credible threat. Finally, accommodation and familarization on the part of the browsing animals causes the stimuli to be ignored, creating a credibility problem of sorts, with the animals in question knowingly and cautiously proceeding in spite of the presence of the nominally repulsive substances.

The prior art teaches delivery methods to introduce repellent substances into the ambient environment as a stimulus. U.S. Pat. No. 5,083,708 to Walters teaches the use of small elongated spike-like repellent units with pointy ends that contain a repellent substance that diffuse out through a large opening and feature a frangible barrier that allows selective breakage of a seal exposing the active ingredient to the air.

U.S. Pat. No. 5,379,545 to Gall et al. discloses a container with a roof that allows diffusion of a compound contained therein via large square side openings, and featuring a ground engaging spike or pin.

In a similar vein, U.S. Pat. No. 6,192,621 to Fain also discloses a ground-engaging pin equipped container with a roof and open sides to allow diffusion of the active contents.

Delivery methods play a critical role in reducing the probability that a deer or ruminant or other animal will not undergo accommodation or familiarization. The delivery methods found in the prior art do not address this, as the repellent containers are not credible in their presentation. Deer and other ruminants will often smell closely the object of a new stimuli, and “write-off” or discount the perceived threat posed by a ground-mounted vial or other container containing an odoriferous material.

It is therefore one objective of this invention to provide a credible, effective deterrent using commonly available repellent substances, and having long effective lifetimes, with reduced possibility of physical chemical, or biological degradation.

It is another objective of this invention to provide an effective deterrent method which relies on the extreme sensitivity of ruminants' olfactory systems and their inherent behaviors which provide for the survival of the species, while maintaining credibility and effectiveness for a long time period, without accommodation or familiarization.

It is yet another objective of this invention to provide a repellent body for containing a repellent substance which has a reduced surface to volume ratio and reduce porosity, to extend the effective deterrent effect of the repellent substance to long periods.

Other objectives will become apparent upon reading the remainder of the specification and the appended claims.

### SUMMARY OF THE INVENTION

The instant invention provides unexpected findings in that the deterrent effect for known repellents is greatly enhanced beyond that which is anticipated by the prior art. A number of important factors have been discovered which enhance effectiveness, credibility and the effective lifetime of the repellent substance(s) used. Some of these factors are [1] using a repellent body having a limited surface/volume ratio and Low porosity, to extend content lifetime and reduce physical chemical and biological degradation, as previously discussed; [2] locating the repellent body at browsing height; [3] Hanging the repellent body from plant branches or the equivalent, and possibly hiding the repellent body by judicious placement in or about foliage, reminiscent of what an animal might do for its larvae or eggs; [4] Employing a shiny or specularly reflecting outer surface on at least part of the repellent body; [5] Having the repellent body so formed or constructed as to be ovoid in shape; and [6] Using Milorganite® as a repellent substance.

Disclosed is a method for deterring ruminants and other animals from browsing an area using a low porosity ovoid repellent body, the method comprising:

[1] Placing a repellent substance inside the tow porosity repellent body;

[2] Appending the repellent body in the area to be protected;

[3] The repellent body ovoid in shape, and so sized and placed as to be perceived by the ruminants during the browsing.

Additionally the method can comprise: appending the the repellent body a browsing height for the ruminants and other animals; employing a surface to volume ratio for the repellent body of less than 3/cm.; having the repellent body comprise a plurality of pores such that a porosity of the repellent body is between ½ to 50 percent; having the repellent body appended so as to be hanging from an attachment point; having the repellent body appended so as to be substantially partially hidden from a view of the ruminants and other animals; having the repellent substance at least partly derived from activated sewage sludge, or partly derived from blood meal or both; having the repellent body comprise a substantially spherical body capable of being replenished with the repellent; and having the repellent body comprise at least 100 physical pores and a porosity of between 2 and 30 percent.

Also disclosed is a method for deterring ruminants and other animals from browsing an area using a porous ovoid specular-reflecting repellent body, the method comprising:

[1] Placing a repellent substance inside the repellent body;

[2] Appending the repellent body in the area to be protected;

[3] The repellent body ovoid in shape, and so sized and placed as to be perceived by the ruminants during the browsing, and exhibiting at least some specular reflection.

Additionally the method can comprise: appending the the repellent body a browsing height for the ruminants and other animals; employing a surface to volume ratio for the repellent body of less than 3/cm.; having the repellent body appended so as to be hanging from an attachment point; having the repellent body appended so as to be substantially partially hidden from a view of the ruminants and other animals; having the repellent substance at Least partly derived from activated sewage sludge, or partly derived from blood meal, or both; having the repellent body comprise a substantially spherical body capable of being replenished with the repellent; and having a surface of the repellent body possess a specular reflection is factor of at least 20 percent.

Additionally, the invention discloses an ovoid specular-reflecting repellent body for use in deterring ruminants and other animals from browsing, the repellent body comprising:

[1] A container so formed as to have a porosity of between ½ and 50 percent;

[2] A repellent substance inside the container;

[3] The container ovoid in shape, and so sized and placed as to be perceived by the ruminants during the browsing.

The container of the repellent body can be so treated and formed as to exhibit at least some specular reflection perceivable by the ruminants and other animals during browsing.

### BRIEF DESCRIPTION OF THE DRAWINGS

FIG. 1 shows a surface view of a hanging ruminant repellent body in use according to the present invention;

FIG. 2 shows another surface view of a hanging ruminant repellent body in use according to the present invention, partially hidden by foliage;

FIG. 3 gives a simple Cartesian graphical representation of Deterrent Lifetime versus Porosity for a hanging ruminant repellent body in use according to the present invention;

FIG. 4 shows a basic schematic block diagram of possible stimuli and perceptions for a hanging ruminant repellent body in use according to the present invention;

### DEFINITIONS

The following definitions shall be employed throughout:

“Appending” shalt refer to any kind of placement of a repellent body, such as by hanging, clipping, nailing, affixing, etc.

“Arteriodactyl” shall include members of the mammalian order Artiodactyla, also known as even-toed ungulates, including pigs, camels, chevrotains, deer, giraffes, pronghorn, antelopes, sheep, cattle and goats.

“Browsing” shall refer to any investigational activity or eating behavior on the part of an animal in an area to be protected, commonly associated with subsequent invasive or destructive behavior such as tearing of leaves, branches, etc.

“Browsing height” shall refer to the physical height from the earth or terrain on which an animal browses or is expected to browse, during customary body poses or positions. It is a general term, and varies from animal to animal.

“Low porosity” shall refer to a reduced porosity of any repellent body with respect to diffusion of a repellent substance, relative to a porosity afforded by at least some significant direct exposure of the repellent substance to the elements or outside air.

“Non-matte surface” shall refer to any surface, such as found on a repellent body which exhibits primarily non-diffuse reflection, possibly having a shiny or mirrorlike appearance. A non-matte surface shall be construed differently from a matte surface, in that a matte surface is non-image forming and not shiny.

“Ovoid” shall refer generally to 3-dimensional shapes resembling an egg, ovum or eye in animals, and shall include spheres; ellipsoids; oval ellipsoid shapes; cubes; rectangular solids; and forms that are quasi-spherical in 3-dimensional shape or forms that merely have portions that are somewhat spherical rounded or globular. For the purpose of the appended claims, ovoid shall include all compact forms, whether or not they possess squared corners, sharp edges, and the like.

“Pores/Porosity” shall refer generally to those qualities of a material body, such as a repellent body, which allow diffusion of a repellent substance through the repellent body, and includes structural features like pores, holes, gratings, films, or screens that are consistent with secureably containing or holding the repellent substance, while at the same time allowing escape of molecules of the repellent substance in a controlled manner. Porosity shall include effective porosity afforded by diffusion of a repellent substance through such structural features.

“Reflection” shall denote any abrupt change in the direction of propagation of a light wave impinging upon a surface, such as that of a repellent body.

“Ruminant” shalt include any mammal of the suborder Ruminantia (order Artiodactyla), which includes pronghorns, giraffes, okapis, deer, chevrotains, cattle, antelopes, sheep, and goats, or any animal having have three or four-chambered stomachs and a two-toed foot. Included are camels and chevrotains with three-chambered stomachs. This definition shall also include animals that eat quickly, storing masses of grass or foliage in a first chamber of the stomach, (e.g., rumen) for softening, and for later regurgitation and processing.

“Repellent body” shall refer to any container or 3-dimensional body so formed and constructed as to hold a repellent substance, and to possess some physical porosity to allow escape of repellent molecules therefrom.

“Repellent substance” or or “repellent” shall refer to any repellent matter known to alter the course of animal behavior, especially noxious substances that deter further contact, or biological and chemical products produced by predators, that discourage lingering about an area.

“Specular reflection” shall refer to any reflection of electromagnetic water waves in which the reflected waves travel in a definite direction, and where the angle of incidence and the angle of reflection (angles of the directions of the of the incident and reflected waves, respectively, with a line perpendicular to the reflecting surface) are equal and are lying in the same plane. Included here are the terms direct reflection; mirror reflection; and regular reflection, and the properties of non-matte surfaces.

“Specular reflection factor” shall denote the ratio of specular reflected light to incident light.

“Surface” shall denote outer surface, viewed by animals, unless otherwise suggested.

### DETAILED DESCRIPTION OF THE INVENTION

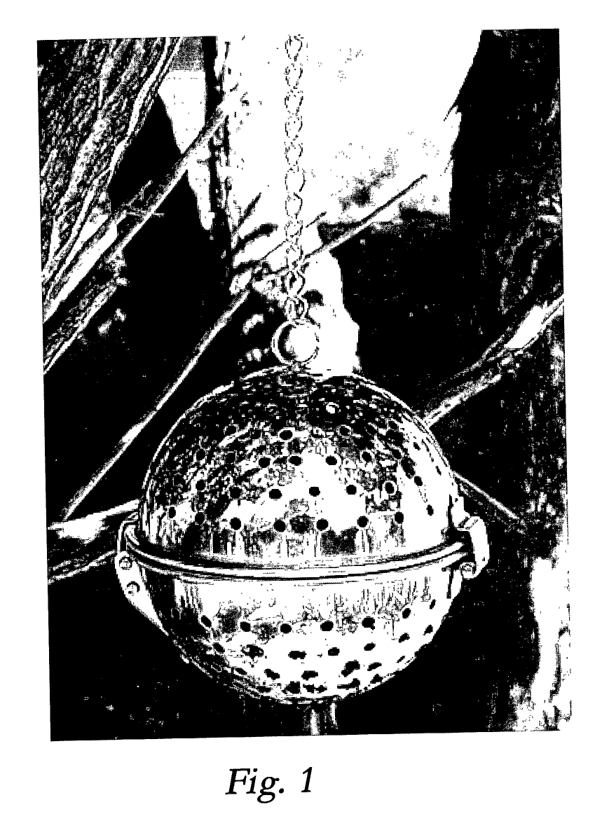

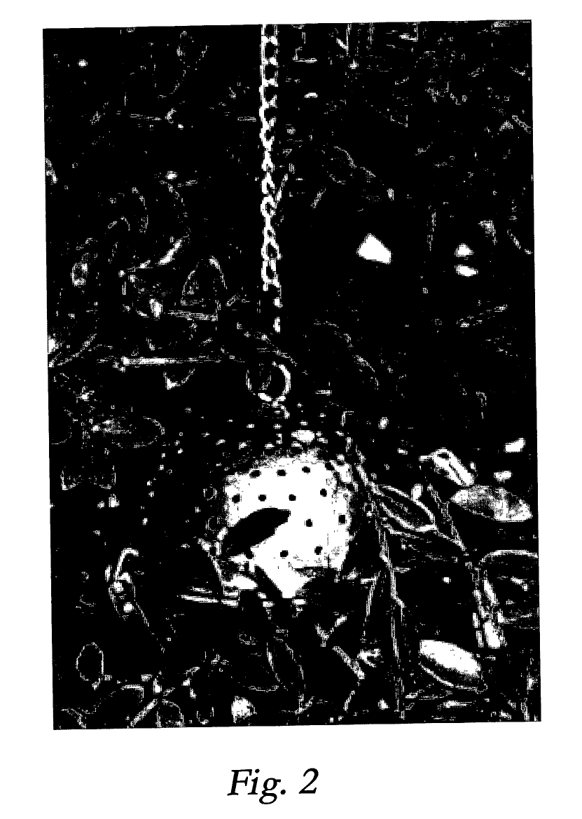

Referring to FIG. 1, a surface view of a hanging ruminant repellent body in use according to the present invention is shown, surrounded by tree branches. Referring also to FIG. 2, another surface view of a similar hanging ruminant repellent body in use according to the present invention is shown, partially hidden by foliage. In these figures, a repellent body having a hollow steel globe-like construction is shown, defining a cavity therein which is approximately spherical and which is capable of holding a repellent substance. This spherical or near-spherical container is hinged with a selectively actuatable clasp, to allow replenishing the contents periodically. The fabrication of this quasi-spherical body, including any hinges, clasps, or doors for replenishment of contents is well known in the mechanical arts. The repellent body is shown hanging from a small chain from a branch (not shown), using an attachment point and hook/loop (both not shown). As can be seen in the definition section of this disclosure, alternative structures not shown here, and obvious to those with ordinary skill in the mechanical arts, can be employed to provide equivalent function, such as an ovoid-shaped screen, porous fabric or resin bag, or the Like, can be substituted for the structure shown and described here.

As has been stated in the Summary of the Invention, it has been discovered that one gets better results by Limiting outgassing or diffusion of the active agent. This is achieved by using a repellent body which is large enough that the surface to volume ratio is less than 3/cm, where the area is expressed in cm² and the volume is expressed in cm³. Coupling this with low porosity in the repellent body, greater effective lifetimes of repellents are obtained.

In the repellent body shown, the sphere diameter D is approximately=2.7″ nominal or 6.86 cm in diameter. The volume of this body is therefore approximately V_{body}=4/3 πr3=169 cm³. The surface area of this body is therefore approximately A_{body}=4 πr2=147 cm² and the ratio of surface/volume=A_{body}/V_{body}=approximately 0.87/cm, well under 3/cm as given above.

The repellent body has a plurality of holes or pores incorporated into its construction, with many visible, but also many not shown. In this example shown in FIGS. 1 and 2, the nominal pore diameter Dₚₒᵣₑ=1/10 inch=0.25 cm². This give an individual pore area Aₚₒᵣₑ=πr²=0.05 cm², approximately. The total number of pores, distributed more or less equally about the area of the repellent body is 264, arranged in 16 rows, but this is of course arbitrary. The total pore area Aₚₒᵣₑₛ of the repellent body is therefore Aₚₒᵣₑₛ=264 (0.05 cm²)=a=13.2 cm².

The porosity of the repellent body, which can be explicitly expressed as a ratio of

Aₚₒᵣₑₛ/A_{body}=0.09=9%

which merely expresses the fact that 9 percent of the repellent body surface area consists of holes or apertures. The effective porosity of the repellent body is also a function of molecular flow and fluid (gas) flow properties, and this would take into account frictional, capillary, and other fluid effects, but the measure given here was found useful as a predictor of repellent substance lifetime in the field. Porosities of between ½ and 50 percent were found useful with lower porosity resulting in longer repellent substance effective lifetimes before physical and other degradation rendered the material stale and ineffective. As is known, adding a roof or other lining to the top of the repellent body can aid in preserving the efficacity of the repellent substances, but was not usually needed. As those skilled in the mechanical arts can imagine, one can use a wide variety of possible structures for the repellent body, including ovoid shapes defined by film-like walls with a porosity equivalent to that recommended here in physical effect. The appended claims are drafted accordingly.

It was additionally found that hanging the repellent body at approximately browsing height enhanced the deterrent effect. Browsing height was chosen to match that of the bulk of animals in question. Ground placement was not as effective. In addition, hiding the repellent body somewhat was found to improve effectiveness, as mentioned elsewhere in this disclosure.

In the course of this invention, an unexpected finding was revealed, namely that commonly available Milorganite® acts as an effective repellent when used in the context of the methods of this invention.

Milorganite is a trade name for an organic, slow-release fertilizer made by the Milwaukee Metropolitan Sewerage District (MMSD) in Milwaukee, Wis., USA. The formulation came about by way of a biochemical discovery in 1913, and its use allowed skilled agronomists and turfgrass specialists to develop many of the turfgrass practices used worldwide today. Before introduction of Milorganite, fertilizers available for care of turfgrass were problematic or posed burn risks to plant life, such as the use of manures, dried blood products, organic compost materials, or ammonium sulfate and other inorganic products. In 1913, legislation authorized the City of Milwaukee to create a sewerage commission charged with cleaning up Milwaukee's three rivers—the Milwaukee, Menomonee, and Kinnickinnic Rivers, which flow into Lake Michigan. At that time, a chemist in Birmingham, England, was experimenting with biosolids in sewage sludge, who discovered the activated sludge process by aerating wastewater and collecting the settled mixture. This activated sludge process was adopted for use by the Milwaukee Sewerage Commission Laboratory December, 1919. In 1921 interceptor sewers were installed to connect municipal sewers to allow centralized wastewater processing at Jones Island, on the shore of Lake Michigan, the site of the world's first Large scale activated sludge plant in 1923. In the course of insuring clean water supplies, the MMSD was faced with significant quantities of biosolids left from the activated sludge process. Research at the University of Wisconsin College of Agriculture, under the direction of Dr. Emil Truog, investigated uses of activated sludge as a fertilizer. A research fellow, O. J. (Oyvind Juul) Noer determined that the activated sludge biosolids were 6.2 percent total nitrogen, with 5.17 percent being water insoluble nitrogen; 2.63 percent available phosphate and 0.4% soluble potash—closely resembling in a general way high grade organic nitrogenous fertilizers of the day and giving superior growth results compared to manures and chemical fertilizers of the time.

After using the material to experiment on field crops and vegetables such as corn, potatoes, sorghum, cabbage, cauliflower, tobacco, tomatoes and muskmelon, O. J. Noer then used the fertilizer on lawns and found it superior and one-third the cost of other available fertilizers. Advantages included minimized danger of burning turf even with misapplication and the production of dark-green, dense turf without causing excessive top growth. Research plots were established at various golf courses such as the Blackhawk Country Club and Maple Bluff Country Club in Madison, Wis., and other plots across the United States. All gave excellent results. This prompted the MMSD to solve their disposal problem by producing and marketing the fertilizer, which was named Milorganite, derived from the words Milwaukee Organic Nitrogen. Commercial production of Milorganite began in 1926. Milorganite is now considered by many to be the United State's premier organic fertilizer. In the years since, there is a body of research devoted to the study of Milorganite. Through clipping analysis, Noer determined that the basic nutrient ratio in plant tissue was 3:1:2 (Nitrogen: Phosphorus: Potassium) instead of the 1:4:2 originally thought. From these studies came basic Milorganite fertility recommendations still used today in modern turf management regimes. Other research on Milorganite includes studies in environmentally sensitive areas such as nutrient leaching and run-off, disease suppression characteristics of organic fertilizers, and effects on irrigation requirements.

However, the success of Milorganite as a component to be used in a strategy with the teachings given here was unanticipated by this modern research. The effectiveness of Milorganite may be due to its content as a by-product of sewage sludge, and the exposure and porosity characteristics of the methods taught here to cause the material to become sensed. As for the content of Milorganite, its contents are derived from activated sewage sludge, and as such it is likely to contain traces of human steroids, such as from sweat and urine. The apocrine sweat glands in humans, found in the arm pits, around the anus and genitals, are of special interest. In human sweat and urine, steroids such as androstenol, androsterone, dehydorepiandrosterone, 11-ketoaeticholanalone, i-androstanalone, oestrone, oestriol, oestradiol pregnandiol, progesterone, and androstan-3-one are found, and while this may present a complex mix of substances, it is well known that individual components of these secretions and their by-products all chemically belong to steroids found in human skin, hair, urine and sweat. The predominant steroid in axillae sweat is dehydroepiandrosterone sulfate. Many other steroids are secreted onto the skin as sulfates and glucuronides which are picked up by bacteria to become “free” steroids. Of course, steroids are also naturally found in plants. Androstenol is found in truffles. Celery and parsnips and other foods also contain androstenone. However, the actual mix of steroids and their concentrations certainly make human steroid products recognizable. And there are other human waste products in sewage sludge, including trans-3-methyl-2-hexenoic acid, which gives body odor its scent and is found in the axillae of both males and females. It is quite possible that deer and other ruminants are equipped to sense these compounds and draw conclusions, when presented to them in the context of the invention.

Deer, for example, do not respond effectively to Milorganite sprinkled on the ground: they either seem to sense that it is not a bonafide danger sign, or the low biological half life of the material when exposed to the elements causes it to weaken and rapidly become stale.

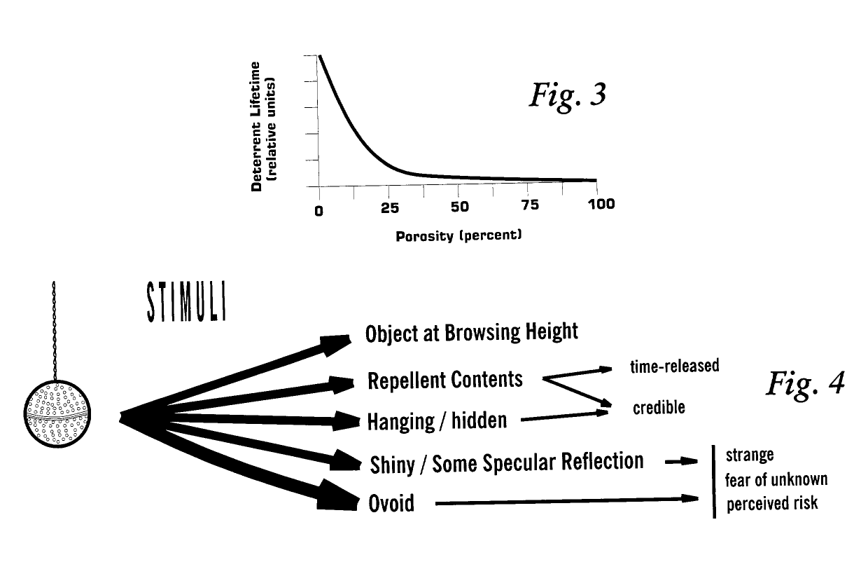

Referring now to FIG. 3 a simple Cartesian graphical representation of Deterrent Lifetime versus Porosity for a hanging ruminant repellent body in use according to the present invention is shown. On the abscissa is given relative porosity in percent (see above discussion), while on the ordinate is given Deterrent Lifetime in rough relative units. It has been discovered that the above mentioned degradation of the repellent substances speeds up rapidly for high porosity repellent bodies that allow their active charge to be exposed to the air and elements, while deterrent lifetimes go up as porosity in percent decreases, as shown in the graph. At zero porosity, the lifetime of the repellent substances is maximized, but of course efficacity would suffer, as diffusion of the deterring species would not be significant.

Another very significant finding is that the shape of the repellent body has a previously unexplained beneficial effect on deterrence value for deer, who, over the course of a three year test, never became accommodated to, or familiarized with, the repellent body or its contents. The prior art has not appeared to anticipate that subtle psychology may be at work here—it could be that animals may consider the repellent ball to be an eye or ovum of some sort, and may wish to depart the area because they do not wish to incur the wrath of a carnivore. This is not so far fetched, as deer are quite intelligent animals. They can, for example, recognize people and upon encountering a new person they have been known to easily distinguish between a man wearing fatigues (likely a hunter) from a runner in shorts, and behave accordingly. They are also likely to not be fooled for long by the smearing of material indiscriminately on tree bark or other outside surfaces for reasons mentioned. At the same time, they are uneasy about the unknown. More importantly, to the extent that the repellent body resembles an eye—in reflection and shape—deer will be repulsed, a finding which is well known throughout all biology for all manner of animals. Even the tuna moth uses this to advantage, by selectively exposing an inner set of wings with the image of large eyes on them to ward off predatory animals like birds. The eye inspires fear and discomfort universally all many species, including prey animals as contemplated here.

Another significant finding is that increased effectiveness come about through the use of a specular or partially specular reflecting (shiny) surface on the repellent body, whether it is made from a solid steel construction as shown here, or using resins or films with a shiny appearance. It has been known from other contexts that deer have at least a passing strong reaction to specularly reflecting or shiny surfaces, and sources of lights such as automotive headlamps, etc. Physically, it is commonly known that a polished steel surface will form a well-defined reflected beam, whereas the bark of a typical tree will not, because it reflects light in more or less all directions (diffuse reflection). The matter of the difference between diffuse and specular reflection concerns in large part surface roughness of the material in question. If the average depth of the surface irregularities or asperities of the reflector is substantially less than the wavelength of the incident light, then specular reflection can occur. For deer, considering their evolution, specular reflection outside of the surfaces of lakes, ponds and the like is almost never encountered. It is believed to mesmerize them to some extent.

Alternatively, the hanging embodiment of the instant invention may interfere with a deer's proper interpretation of the plant or shrub they have intention of browsing. There may be a sense of the unknown, and a preference to go to other browsing opportunities that appear to pose a lesser risk of trouble.

Referring now to FIG. 4, a basic schematic block diagram of possible stimuli and perceptions for a hanging ruminant repellent body in use according to the present invention is shown. Though not all stimuli need be used together to practice this invention, the various effective stimuli are shown—having the repellent body at about browsing height; having timed release of the repellent contents, largely free from the effects of degradation; having the repellent body hanging and/or hidden; employing specular reflection on the repellent body; and using ovoid or eye-like shapes. The latter two stimuli are believed to be strange to ruminants, arousing the fear of the unknown and/or feelings of discomfort, and increasing perceived risk.

For specular reflection, it was found that a specular reflection factor (see definition above) of 20% or more had an effect. One can use well known repellents such as materials derived from blood, urine, feces, sewage sludge, or any other carnivorous biological material inside the repellent body as taught. For example, well known blood meal made from animal blood products, may be added to the repellent mixture. For example, blood meal can be used, such as blood meal under the trade name VIGORO® as available from Vigoro Acquisition Corporation, a wholly owned subsidiary of Pursell Industries of Sylacauga, Alabama. In several trials, the repellent body shown in FIGS. 1 and 2 was filled with

90 g Milorganite

30 g Blood Meal

with the blood meal in the center portion of the spherical repellent body, covered top and bottom with a layer of Milorganite to help further shield the blood meat from degradation. The effective protected radius proved to 3 meters to 6 meters from the repellent body with no browsing damage. The duration of effectiveness was approximately 2 years, and was renewed for a third year successfully merely by replacing the Milorganite/Blood Meal repellent material inside the sphere.

Animals inhibited from browsing included rabbits, hares, deer, and woodchuck, who were deterred from browsing within the above mentioned radius from the hanging repellent body. Plants protected included hosta, day lilies, daisies, irishes, strawberries, hedges and shrubs.

The methods taught here rely on ruminants' highly developed olfactory mechanisms, and use inherent behaviors needed for survival of species—dictated by their psychology and heredity. The delivery system is such that wasteful outgassing of the repellent substances is minimized, yet is targeted for browsing animals in a meaningful and credible way, without without the effects of accommodation and familiarization.

The methods here have been shown to be effective in repelling deer and other ruminants, but the methods taught here can be applied to other species such as rabbits, hares, mice, voles, possums, rats, shrews, skunks, squirrels, chipmunks, ground hogs, woodchucks, gophers, etc.

The invention as disclosed using the above examples may be practiced using only some of the features mentioned above.

Obviously, many modifications and variations of the present invention are possible in light of the above teaching. It is therefore to be understood that, within the scope of the appended claims, the invention may be practiced otherwise than as specifically described or suggested here.

I claim:

1. A method for deterring ruminants and other animals from browsing an area using a low porosity ovoid repellent body, said method comprising:
[1] Placing a repellent substance inside said low porosity repellent body;
[2] Appending said repellent body in said area to be protected;
[3] Said repellent body ovoid in shape, and so sized and placed as to be perceived by said ruminants during said browsing.

2. The method of claim 1, wherein said repellent body is appended at a browsing height for said ruminants and other animals.

3. The method of claim 1, wherein a surface to volume ratio for said repellent body is less than 3/cm.

4. The method of claim 1, wherein said repellent body comprises a plurality of pores such that a porosity of said repellent body is between ½ to 50 percent.

5. The method of claim 1, wherein said repellent body is appended so as to be hanging from an attachment point.

6. The method of claim 1, wherein said repellent body is appended so as to be substantially partially hidden from a view of said ruminants and other animals.

7. The method of claim 1, wherein said repellent substance is at least partly derived from activated sewage sludge.

8. The method of claim 1, wherein said repellent substance is at least partly derived from blood meal.

9. The method of claim 1, wherein said repellent body comprises a substantially spherical body capable of being replenished with said repellent

10. The method of claim 9, wherein said repellent body comprises at least 100 physical pores and a porosity of between 2 and 30 percent.

11. A method for deterring ruminants and other animals from browsing an area using a porous ovoid specular-reflecting repellent body, said method comprising:
[1] Placing a repellent substance inside said repellent body;
[2] Appending said repellent body in said area to be protected;
[3] Said repellent body ovoid in shape, and so sized and placed as to be perceived by said ruminants during said browsing, and exhibiting at least some specular reflection.

11. The method of claim 10, wherein said repellent body is appended at a browsing height for said ruminants and other animals.

12. The method of claim 10, wherein a surface to volume ratio for said repellent body is less than 3/cm.

13. The method of claim 10, wherein said repellent body is appended so as to be hanging from an attachment point.

14. The method of claim 10, wherein said repellent body is appended so as to be substantially partially hidden from a view of said ruminants and other animals.

15. The method of claim 10, wherein said repellent substance is at least partly derived from activated sewage sludge.

16. The method of claim 10, wherein said repellent substance is at least partly derived from blood meal.

17. The method of claim 10, wherein said repellent body comprises a substantially spherical body capable of being replenished with said repellent.

18. The method of claim 10, wherein a surface of said repellent body possesses a specular reflection factor of at least 20 percent.

19. An ovoid repellent body for use in deterring ruminants and other animals from browsing, said repellent body comprising:
[1] A container so formed as to have a porosity of between ½ and 50 percent;
[2] A repellent substance inside said container;
[3] Said container ovoid in shape, and so sized and placed as to be perceived by said ruminants during said browsing.

20. The repellent body of claim 19, wherein said container is so treated and formed as to exhibit at least some specular reflection perceivable by said ruminants and other animals during browsing.
